(19) United States
(12) Patent Application Publication
(10) Pub. No.: US 2005/0210485 A1
(43) Pub. Date: Sep. 22, 2005

(54) Disk device with enhanced heat radiation effects

(75) Inventors: Yasuhisa Ueda, Takefu-city (JP); Norio Takahara, Takefu-city (JP); Toshihiro Tamura, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 11/083,368

(22) Filed: Mar. 18, 2005

(30) Foreign Application Priority Data
Mar. 22, 2004 (JP) 2004-082843

(51) Int. Cl. G11B 33/14

(52) U.S. Cl. 720/649

(57) ABSTRACT

The present invention provides a disk device with enhanced heat radiation effects which aims at effectively suppressing heat generation from a circuit substrate without preventing slimming of a disk device, facilitating assemblies and adjustments in manufacturing steps, and simplifying maintenance/repair work. In the present invention, connectors 18C to be connected to flat cables 18B are intensively disposed close to one edge of a circuit substrate 6, the circuit substrate 6 is fixed between side wall sections 7B, 7B, and a ventilation path for air produced by rotation of a disk 2 is formed by a space enclosed by the circuit substrate 6 and side wall sections 7B. Electronic parts 18 mounted on the circuit substrate 6 are fixed to a frame 7 oriented toward the disk 2 so as to face this ventilation path. This allows the air produced through rotation of the disk 2 to pass through a ventilation path 28 and go out of the frame 7 and allows heat from the electronic parts 18 to radiate outward. At the same time, by removing the circuit substrate 6 with the flat cable 18B connected thereto, it is possible to uncover the upside of the frame 7 and facilitate assembly and adjustment in manufacturing steps.

The present application is based on and claims priority of Japanese patent application No. 2004-082843 filed on Mar. 22, 2004, the entire contents of which are hereby incorporated by reference.

### BACKGROUND OF THE INVENTION

1. Field of the Invention

The present invention relates to a disk device which records/reproduces data on/from the recording surface of a disk by irradiating laser light, and more particularly, to a disk device with enhanced heat radiation effects so as to effectively suppress heat generation from electronic parts mounted on a circuit substrate using an air flow produced during rotation of the disk.

2. Description of the Related Art

In recent years, a disk device is not only used for a DVD player or a CD player, but also built in a television receiver and is being used in this way in an increasingly wide range of applications to meet various kinds of auser's needs. These disk devices are becoming smaller and slimmer year by year and the interior of the device has not enough space causing various devices and parts to be mounted at high densities, which in turn causes heat to be generated at higher densities from electronic parts and the like of an TIC of a drive control circuit housed therein. For this reason, it is becoming an important issue how to prevent misoperation due to a temperature rise during writing or reading operation to/from a disk. As a heat radiation structure for an optical disk device according to such a conventional technology, for example, Japanese Patent Laid-Open Publication No. 2000-231782 (Patent Document 1) and Japanese Patent Laid-Open Publication No. 2000-231783 (Patent Document 2) disclose a cooling device for a disk device which partitions the interior of a casing into upper and lower portions by a mechanical chassis, disposes a main unit provided with a tray for placing a disk thereon, a turn table, a motor for driving the turn table, a pickup for reading data by irradiating the recording surface of the disk with light and a traverse unit for moving this pickup in the radius direction of the disk and the like in an upside section area, disposes a circuit substrate mounted with heat generating electronic parts such as LSI and IC for driving and controlling the pickup and driving mechanism in a downside section area, uses an air flow produced in the upside section area through rotation of the disk and circulates the air through the downside section area. That is, the device described in these Patent Document 1 and Patent Document 2 is designed to enhance the cooling effects of the heat generating electronic parts mounted on the circuit substrate by forming a plurality of vent holes in the mechanical chassis which serves as a partition between the upside and downside section areas, allowing the air flowing through the upside section area to pass through the vent holes into the downside section area through rotation of the disk and circulating the air into the upside section area again through the vent holes.

Thus, the device described in Patent Document 1 or Patent Document 2 is constructed so as to cool the circuit substrate using the air flow produced through rotation of the disk, thereby eliminates the necessity for separately building in a cooling component such as a cooling fan and has the advantage of having the ability to make the disk device compact. However, it partitions the casing into upside and downside section areas by the mechanical chassis, houses the main unit of the disk device in the upside section area, houses the circuit substrate in the downside section area mounted with an integrated circuit and the like, which constitutes a limit to slimming of the disk device, making it impossible to slim the disk device. Moreover, since the circuit substrate is housed in the downside section area, it is extremely complicated to attach/detach the circuit substrate for various adjustments or repair at the time of shipment and the like.

### SUMMARY OF THE INVENTION

The present invention has been implemented in view of the above described problems and it aims at providing a disk device with enhanced heat radiation effects capable of effectively suppressing heat generation from electronic parts mounted on a circuit substrate without preventing slimming of the disk device, providing ease of assembly in manufacturing steps and adjustment and simplifying maintenance and repair work.

The disk device with enhanced heat radiation effects according to a first aspect of the invention is a disk device comprising a tray which loads/unloads a disk, a turn table which rotates/drives the disk, a damper facing the turn table for holding the disk sandwiched therebetween, a pickup lens which irradiates the recording surface of the disk with laser light for recording/reproducing data on/from the disk, a circuit substrate which controls the disk device, and a frame in which these components are assembled, wherein the frame is provided with a support frame which extends in a horizontal direction for guiding the tray and a pair of side wall sections facing each other on both sides of the support frame integrated as a single unit, a strip-shaped support plate for attaching the damper is formed substantially at the center of the upside of the side wall section as an integral part thereof, the circuit substrate is placed so as to span between the side wall sections substantially as high as the support plate to cover the opening of the upside of the frame with the circuit substrate to thereby form a ventilation path in a space enclosed by the circuit substrate and the side wall sections through which air generated during rotation of the disk flows, and the electronic parts mounted on the circuit substrate are allowed to jut out toward this ventilation path.

According to the first aspect of the invention, when the air produced during rotation of the disk is let out from the frame through the ventilation path, heat of the electronic parts mounted on the circuit substrate is radiated to the outer side. Furthermore, since the circuit substrate is simply fixed to the upside of the frame and the electronic parts mounted on the circuit substrate jut out toward the ventilation path, no electronic parts jut out toward the outer surface, and the support plate to which the damper is attached is contiguous to the circuit substrate substantially flush with each other, which makes it possible to suppress the height of the overall disk device and make the disk device as slim as possible.

The disk device with enhanced heat radiation effects according to a second aspect of the invention is the disk device with enhanced heat radiation effects according to the first aspect of the invention, wherein the drive system unit such as the feeding mechanism for a pickup lens fixed to the frame and a turn table is electrically connected to the circuit substrate using a wiring member with flexibility and connectors to be connected to the wiring member are intensively disposed at one edge of the circuit substrate.

According to the structure of the second aspect of the invention, it is possible to remove the circuit substrate from the wiring member by turning around the circuit substrate with the wiring member connected to the circuit substrate so as to uncover the upside of the frame.

The disk device with enhanced heat radiation effects according to the first aspect of the invention is a disk device comprising a tray which loads/unloads a disk, a turn table which rotates/drives the disk, a clamper facing this turn table for holding the disk sandwiched therebetween, a pickup lens which irradiates the recording surface of the disk with laser light for recording/reproducing data on/from the disk, a circuit substrate which controls the disk device, and a frame in which these components are assembled, wherein the frame is provided with a support frame which extends in a horizontal direction for guiding the tray and a pair of side wall sections facing each other on both sides of this support frame integrated as a single unit, a strip-shaped support plate for attaching the damper is formed substantially at the center of the upside of the side wall section as an integral part thereof, the circuit substrate is placed so as to span between the side wall sections substantially as high as the support plate to cover the opening of the upside of the frame with the circuit substrate to thereby form a ventilation path in the space enclosed by the circuit substrate and the side wall sections through which air generated during rotation of the disk flows and the electronic parts mounted on the circuit substrate are allowed to jut out toward this ventilation path, and therefore when the air produced during rotation of the disk is let out from the frame through the ventilation path, it is possible to radiate heat outward from the electronic parts mounted on the circuit substrate for a driver for driving various motors and the like and for heat generating electronic parts for performing various types of control in particular. This prevents heat from the electronic parts from being entrapped inside and allows heat of the electronic parts mounted on the circuit substrate to radiate effectively. Furthermore, since the ventilation path is formed by fixing the circuit substrate which is indispensable from the standpoint of the structure of the disk device to the frame, it is not necessary to use any additional heat radiating part, the electronic parts face the ventilation path without jutting out toward the outer surface, the support plate to which the damper is attached is contiguous to the circuit substrate substantially flush with each other, which makes it possible to suppress the height of the overall disk device and make the disk device as slim as possible.

The disk device with enhanced heat radiation effects according to the second aspect of the invention is the disk device with enhanced heat radiation effects according to the first aspect of the invention, wherein the drive system unit such as the feeding mechanism for a pickup lens fixed to the frame and a turn table is electrically connected to the circuit substrate using a wiring member with flexibility and connectors to be connected to the wiring member are intensively disposed at one edge of the circuit substrate so as to provide the wiring member with a hinge function when attaching/detaching the circuit substrate, and therefore it is possible to remove the circuit substrate from the wiring member by turning around the circuit substrate with the wiring member connected to the circuit substrate so as to uncover the upside of the frame, easily attach a traverse unit and the like to the disk device in manufacturing steps of the disk device from the upper opening of the disk device, which improves operability and provides flexibility for the work processes. Furthermore, when carrying out repair or maintenance, the presence of the substrate above the disk device facilitates the work a great deal and allows various types of adjustments to be made with the wiring member connected to the circuit substrate, which drastically shortens the operation time.

### BRIEF DESCRIPTION OF THE DRAWINGS

FIG. 1 is a perspective view of a disk device showing an embodiment of the present invention;

FIG. 2 is a perspective view of the disk device with the circuit substrate removed from the frame according to the embodiment of the present invention;

FIG. 3 is a perspective view of the disk device separated into the circuit substrate and the frame according to the embodiment of the present invention;

FIG. 4 is a plan view of the disk device without the circuit substrate according to the embodiment of the present invention;

FIG. 5 is a cross-sectional view along a line A-A in FIG. 1; and

FIG. 6 is a cross-sectional view along a line B-B in FIG. 1.

### DETAILED DESCRIPTION OF THE PREFERRED EMBODIMENTS

With reference now to the attached drawings, one specific preferred embodiment of the present invention will be explained below. Please note that the following embodiment is an embodiment for actually implementing the present invention and not intended to limit the present invention to within the scopes thereof.

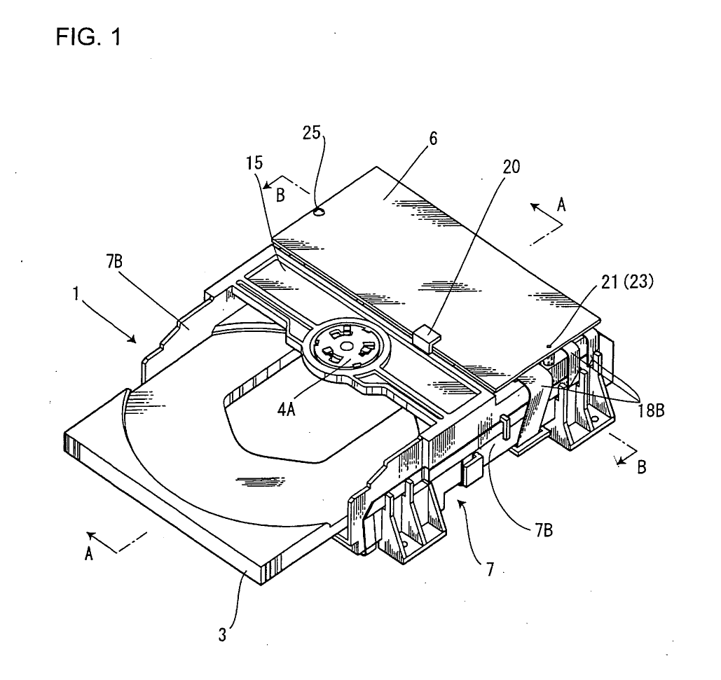

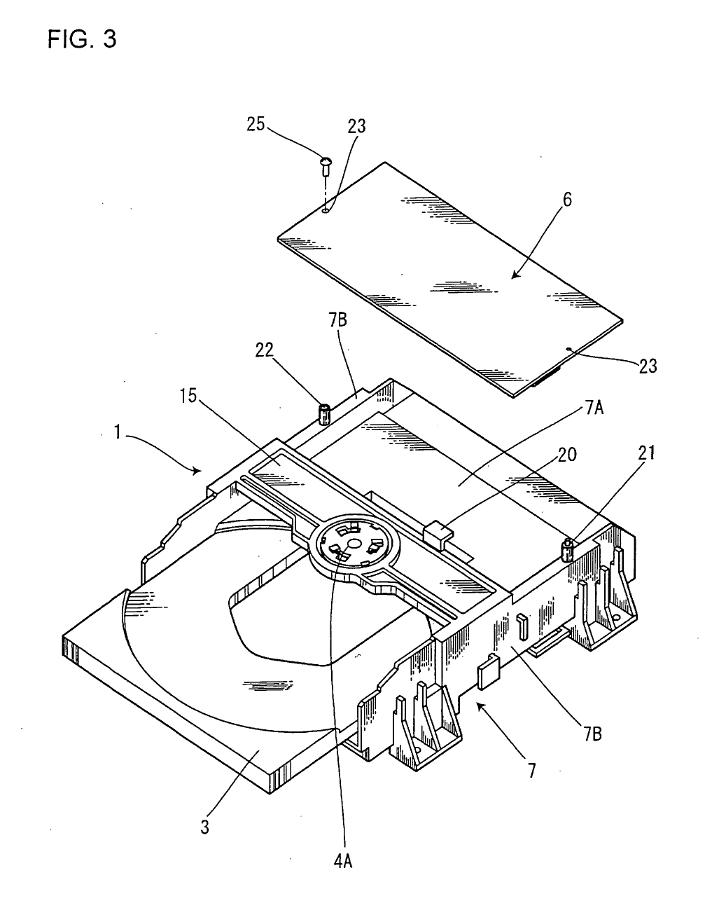

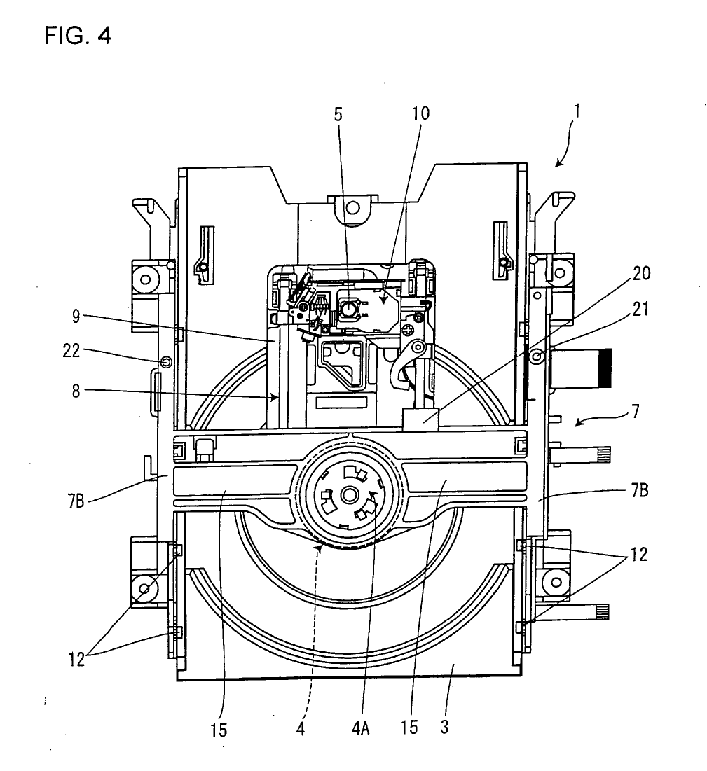

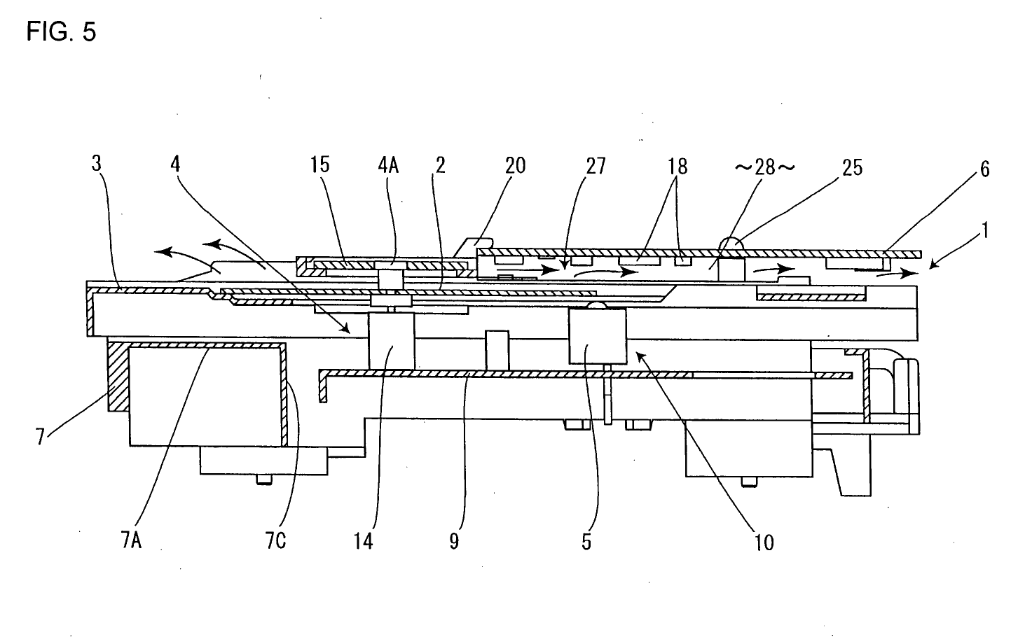

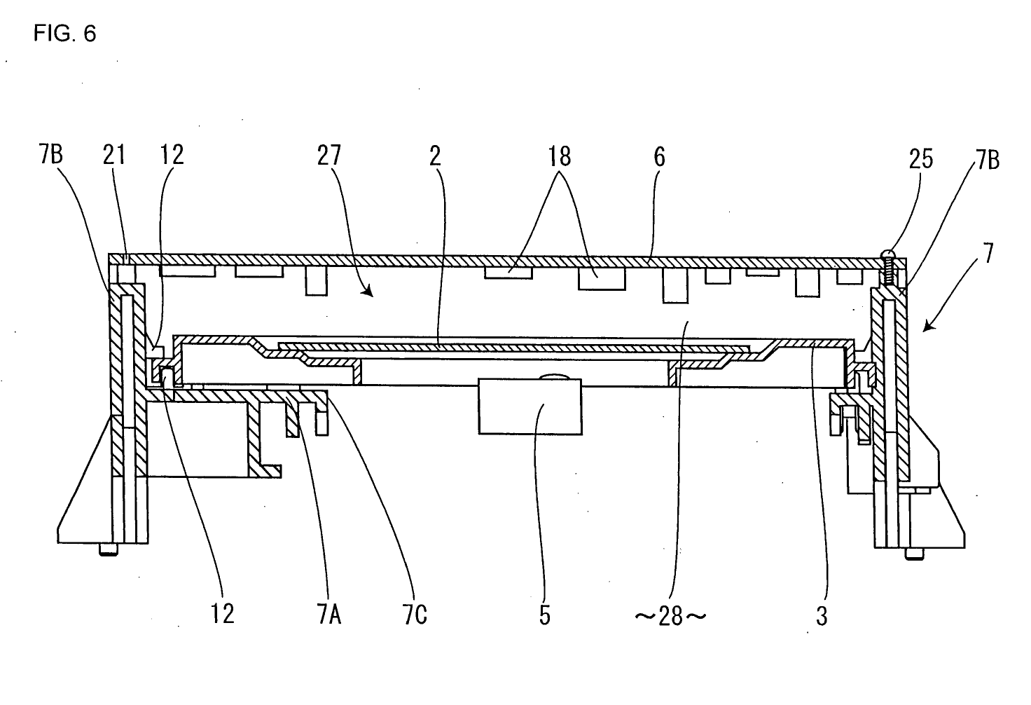

As shown in FIGS. 1 to 6, the disk device 1 of this embodiment is mainly constructed of a tray 3 for loading/unloading a disk 2, a turn table 4 for rotating/driving the disk 2, a clamper 4A facing this turn table for holding the disk 2 sandwiched therebetween, a pickup lens 5 provided in a manner movable forward or backward in the radius direction of the disk 2 and a circuit substrate 6 on which a circuit for driving/controlling the disk device 1 is formed, and these main components are assembled in a frame 7 made of synthetic resin. Furthermore, the turn table 4, pickup lens 5, and a feeding mechanism 8 therefor are fixed to a metallic support frame 9 integrated into a drive system unit 10. Furthermore, the frame 7 is constructed of a support frame 7A which extends in the horizontal direction and side wall sections 7B formed on right and left sides of and integral with this support frame 7A and the drive system unit 10 is fixed oriented toward an opening 7C formed in the support frame 7A, wherein rails 12 for guiding the tray 3 is formed on the inner surfaces of the side wall sections 7B so that the tray 3 can be moved back and forth with respect to the frame 7 along these rails 12.

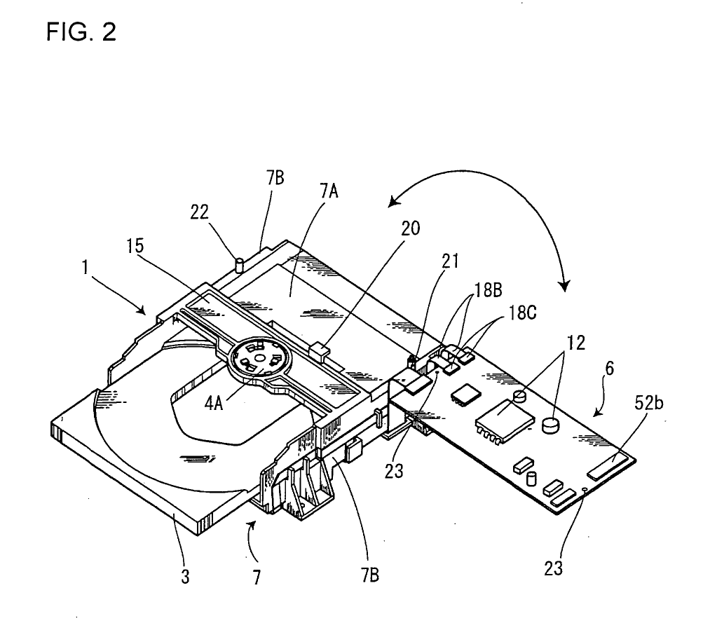

The turn table 4 is constructed so as to rotate through rotation and driving of a spindle motor 14 disposed substantially at the center of the frame 7. A strip-shaped support plate 15 is disposed above this turn table 4 spanning between the side wall sections 7B of the frame 7 integrated as a single unit. The damper 4A is fixed at the center of this support plate 15 and this damper 4A and turn table 4 are constructed so as to hold the disk 2 therebetween to rotate the disk 2. The circuit substrate 6 on which various electronic parts 18 are mounted is disposed behind the support plate 15. The circuit substrate 6 is fixed to the frame 7 spanning the upsides of the right and left side wall sections 7B and an L-figured stopper 20 is formed integral with the support plate 15 of the frame 7 to stop the circuit substrate 6 and a dowel pin 21 and a fixing hole 22 for fixing the circuit substrate 6 are formed in the side wall sections 7B, 7B of the frame 7. On the other hand, holes 23, 23 are formed at positions corresponding to the dowel pin 21 and fixing hole 22 of the circuit substrate 6 respectively and the circuit substrate 6 is fixed to the frame 7 with the front end of the circuit substrate 6 fixed by the stopper 20 by fitting the dowel pin 21 into one hole 23 and screwing a fixing screw 25 inserted into the other hole 23 into the fixing hole 22. Here, the circuit substrate 6 is fixed between the side wall sections 7B, 7B of the frame 7 in such a way that the electronic parts 18 mounted on the circuit substrate 6 face the disk 2, that is, the inner surface side. In this way, by covering the upside opening of the frame 7 with the circuit substrate 6 fixed between the sidewall sections 7B, 7B, a space 27 enclosed by the circuit substrate 6 and side wall sections 7B of the frame 7 is formed with the disk 2 loaded and this space 27 forms a ventilation path 28 through which the air generated through rotation of the disk 2 flows. Connectors 18C are intensively disposed at one edge of the circuit substrate 6 fixed to the frame 7, flexible flat cables (hereinafter simply referred to as “flat cables”) 18B are connected to these connectors 18C as flexible wiring members and through these flat cables 18B, the circuit substrate 6, the drive system unit 10, and the like fixed to the frame 7 are electrically connected. Thus, by intensively disposing the connectors 18C to be connected to the flat cables 18B close to one edge of the circuit substrate 6, it is possible, as shown in FIG. 2, to remove the circuit substrate 6 by turning around the circuit substrate 6 from the flat cable 18B side with the flat cables 18B connected to the circuit substrate 6 to uncover the upside of the frame 7.

According to the embodiment having the above described arrangement, the circuit substrate 6 is fixed between the side wall sections 7B, 7B, the opening of the upside of the frame 7 is covered with this circuit substrate 6, the pace 27 enclosed by the circuit substrate 6 and the side wall sections 7B of the frame 7 is thereby formed and the ventilation path 28 through which the air produced by rotation of the disk 2 flows is formed from this space 27. Then, the electronic parts 18 mounted on the circuit substrate 6 are oriented toward the disk 2 so as to face this ventilation path 28 and fixed to the frame 7 and an air flow is produced through the rotation of the disk 2, and it is possible to radiate heat to the outer side from the electronic parts 18 mounted on the circuit substrate 6 using this air flow. This prevents the heat radiated from the electronic parts 18 from being entrapped in the space 27 enclosed by the circuit substrate 6 and side wall sections 7B of the frame 7, making it possible to let out heat from the frame 7 and efficiently radiate heat from the electronic parts 18 mounted on the circuit substrate 6. Furthermore, the circuit substrate 6 is exposed and fixed to the upside of the frame 7 and the electronic parts 18 of the circuit substrate 6 are mounted inward in such a way as to face the ventilation path 28, which prevents the electronic parts 18 from jutting out from the outer surface of the circuit substrate 6. This causes the non-mounting side of the circuit substrate 6 to be contiguous to the support plate 15 to which the clamper 4A is attached flush with each other, thus suppressing the height of the disk device 1.

As shown above, this embodiment forms the ventilation path 28 through which the air produced through rotation of the disk 2 flows by covering the opening of the upside of the frame 7 with the circuit substrate 6, fixes the electronic parts 18 mounted on the circuit substrate 6 oriented toward the disk 2 so as to face this ventilation path 28, and can thereby effectively radiate heat from the electronic parts 18 toward the outer side of the frame 7 using the air flow produced through rotation of the disk 2. This prevents heat radiated from the electronic parts 18 from being entrapped in the space 27 enclosed by the circuit substrate 6 and side wall sections 7B of the frame 7, making it possible to let out heat from the frame 7, efficiently radiate heat from the electronic parts 18 mounted on the circuit substrate 6 and prevent deterioration of the electronic parts 18 due to heat. Furthermore, since the ventilation path 28 is formed by fixing the circuit substrate 6 which is indispensable for the structure of the disk device 1 to the frame 7, there is no need to additionally use heat radiating parts and it is possible to reduce the number of parts assembled and simplify the assembly work. Moreover, since the circuit substrate 6 is simply fixed to the upside of the frame 7, it has a simple structure, and the electronic parts 18 of the circuit substrate 6 are mounted inward so as to face the ventilation path 28 and the electronic parts 18 do not jut out from the outer surface of the circuit substrate 6, which causes the non-mounting side of the circuit substrate 6 to be contiguous to the support plate 15 to which the damper 4A is attached substantially flush with each other, thus suppressing the height of the disk device 1 is possible and making the disk device 1 more compact and slimmer. Furthermore, the circuit substrate 6 is fixed to the upsides of the side wall sections 7B of the frame 7 spanning the upsides of the side wall sections 7B and the connectors 18C to be connected to the flat cables 18B are intensively disposed close to one edge of the circuit substrate 6, and it is therefore possible to remove the circuit substrate 6 from the flat cable 18B side by turning around the circuit substrate 6 to uncover the upside of the frame 7. In this way, the upside of the disk device 1 is uncovered by removing the circuit substrate 6, and therefore it is possible to easily replace parts provided inside the disk device 1 and remove the circuit substrate 6 with the flat cables 18B connected. This facilitates various types of adjustment work and drastically reduces working steps and durations.

One preferred embodiment of the present invention has been described in detail as above, however, the present invention is not limited to this embodiment and can be implemented modified in various ways within the scopes of the present invention. For example, the mounting structure of the circuit substrate 6 and basic structure of the disk device are not limited to the above described embodiment, and can be selected as appropriate. Furthermore, this embodiment has described the tray type disk device, however, the present invention is also applicable to a variety of disk devices such as a slot-in type disk device in which a disk is inserted into the device by a loading roller and a changer type disk device capable of housing a plurality of disks in the device.

1. A disk device with enhanced heat radiation effects comprising a tray which loads/unloads a disk, a turn table which rotates/drives the disk, a damper facing the turn table for holding the disk sandwiched therebetween, a pickup lens which irradiates the recording surface of the disk with laser light for recording/reproducing data on/from the disk, a circuit substrate which controls the disk device, and a frame in which the components are assembled, wherein the frame is provided with a support frame which extends in a horizontal direction for guiding the tray and a pair of side wall sections facing each other on both sides of the support frame integrated as a single unit, a strip-shaped support plate for attaching the clamper is formed substantially at the center of an upside of the side wall sections as an integral part thereof, the circuit substrate is placed so as to span between the side wall sections substantially as high as the support plate to cover the opening of the upside of the frame with the circuit substrate to thereby form a ventilation path in a space enclosed by the circuit substrate and the side wall sections through which air generated during rotation of the disk flows, and the electronic parts mounted on the circuit substrate are allowed to jut out toward the ventilation path.

2. The disk device with enhanced heat radiation effects according to claim 1, wherein a drive system unit such as a feeding mechanism for a pickup lens fixed to the frame and a turn table is electrically connected to the circuit substrate using a wiring member with flexibility and connectors to be connected to the wiring member are intensively disposed at one edge of the circuit substrate.
